(19) United States
(12) Patent Application Publication
(10) Pub. No.: US 2017/0015901 A1
(43) Pub. Date: Jan. 19, 2017

(54) Ceramic Phosphor Target

(71) Applicants: OSRAM SYLVANIA INC., Wilmington, MA (US); OSRAM GMBH, Munich (DE)

(72) Inventors: Alan Lenef, Belmont, MA (US); James Avallon, Beverly, MA (US); John Kelso, Exeter, NH (US); Maxim Tchoul, Winchester, MA (US); Yi Zheng, Lynnfield, MA (US); Oliver Mehl, Berlin (DE); Peter Hoehmann, Berlin (DE); Markus Stange, Berlin (DE); Tobias Gleitsmann, Michendorf (DE)

(73) Assignees: OSRAM SYLVANIA Inc., Wilmington, MA (US); OSRAM GmbH, Munich (DE)

(21) Appl. No.: 15/113,239

(22) PCT Filed: Jan. 26, 2015
(86) PCT No.: PCT/US15/12828

§ 371 Date: Jul. 21, 2016

Related U.S. Application Data
(60) Provisional application No. 61/931,946, filed on Jan. 27, 2014.

(51) Int. Cl. C09K 11/77; C04B 37/02; G03B 21/20; C08K 3/22; G02B 7/00; H01S 3/00; C09K 11/08; C09J 183/04

(52) U.S. Cl. CPC C09K 11/7774; C09K 11/7734; C09K 11/0883; C04B 37/028; C09J 183/04; C08K 3/22; G02B 7/008; H01S 3/005; G03B 21/204; C04B 2237/16; C04B 2237/343; C04B 2237/36; C04B 2237/40; C04B 2237/708; C08K 2003/2296; C09J 2205/102

(57) ABSTRACT

There is herein described a ceramic phosphor target which may be used in a laser-activated remote phosphor application. The target comprises a substantially flat ceramic phosphor converter comprised of a photoluminescent polycrystalline ceramic which is attached to a reflective metal substrate by a high thermal conductivity adhesive.

### CROSS REFERENCES TO RELATED APPLICATIONS

This application claims the benefit of U.S. Provisional Application No. 61/931,946, filed Jan. 27, 2014.

### BACKGROUND OF THE INVENTION

In projection and display optics applications, light sources must have low étendue to efficiently couple into the optical system. Equivalently, this implies that the light source has high radiance. A laser is ideal in principle for such applications because it has either a small source size, small angular deviation, or both. Lasers however generate light in very narrow spectral regions and are normally limited in spectral choices. One way to achieve high radiance for white light, or over a broader desired spectral range, is to employ a short wavelength laser to excite (pump) a phosphor which down-converts the incident light to longer wavelengths. By focusing or concentrating the laser light onto the phosphor, one can obtain a small spot size and therefore a low étendue. This approach is often called laser-activated remote phosphor (LARP) technology.

One effective method is a reflective approach, where the phosphor is embedded in a reflective surface so that backward directed luminescent light is returned back in the direction of the laser source by traversing back through the phosphor. In order to have effective light recycling, the reflective surfaces must have very high reflectance, and losses in the phosphor at recycling wavelengths must be low. Furthermore, the low étendue required for projection and display applications requires that the incident laser light have a high intensity which can lead to excessive heating of the phosphor, limiting achievable power levels and causing degradation of the phosphor. The heating of the phosphor is caused by the Stokes shift of the phosphor, non-radiative losses in the phosphor (non-unity quantum efficiency), and losses in the bulk and the reflective surfaces.

In present day commercial systems, powder phosphor is embedded in silicone which is deposited and cured onto a reflective rotating wheel. The rotation is required to minimize heating of the phosphor which would otherwise degrade conversion efficiency or lead to decomposition of the phosphor. Related approaches include the laser raster scanning image generation.

### SUMMARY OF THE INVENTION

The disclosed invention is a reflective remote phosphor design that has considerably improved performance over previous reflective remote phosphor approaches. In particular, the invention can operate at much higher incident laser intensities before conversion saturates from phosphor heating. The invention therefore provides much greater converted power and radiance than in previous approaches. The invention also uses robust materials to minimize or eliminate degradation effects, therefore greatly extending the lifetime of the phosphor target. Thirdly, the phosphor is a high-scattering material which confines both incident exciting laser light and the luminescent converted light. This produces larger absorption of incident light and provides considerable backscattering of luminescent light. These effects help reduce the reflectivity requirements on the reflective surfaces needed to efficiently recycle light and confine the emission spot.

The invention has several benefits:
a) The phosphor material, which is a photoluminescent polycrystalline ceramic, has a high thermal conductivity that reduces thermal saturation and permits operation at higher radiances in a static configuration, thereby eliminating costly components such color wheels, motor control circuits, and other associated components.
b) The use of ceramic phosphors permits good control over activator doping levels, scattering, and geometry, providing a high degree of engineering freedom and manufacturing control.
c) By using properly determined scattering parameters, high conversion efficiencies are achieved with less sensitivity to the reflectivities of bounding surfaces and with better confinement of the luminescent spot. This implies good performance can be achieved with lower reflectivity, non-silvered reflective surfaces for recycling. Furthermore, there is no need for recycling reflectors on the sides of the ceramic phosphors to prevent undesired side emission through the converter.
d) By orienting a cambered ceramic concave-up or a flat ceramic converter on the reflective substrate and bonding with non-absorbing filled silicones which simultaneously satisfy requirements for high thermal conductivity, high-temperature stability, and minimal bond line thickness for low overall thermal resistance, the thermal bottleneck between heated ceramic and substrate is minimized. This further increases radiance and power limits.
e) Fabrication of target assembly is simple and controllable, further aiding manufacturability and reducing cost.
f) The design can be scaled over a wide range of power and radiance levels.
g) The use of high-scattering ceramics provides high backscattering, high incident laser absorption, lower activator concentration for increased quantum efficiency and better thermal quenching behavior, well confined emission spots, and enhanced extraction, especially compared to single crystal phosphors.

In accordance with an aspect of the invention, there is provided a target for a laser-activated remote phosphor application wherein the target comprises a substantially flat ceramic phosphor converter and a reflective metal substrate. The ceramic phosphor converter is comprised of a photoluminescent polycrystalline ceramic and is attached to a reflective surface of the metal substrate by a high thermal conductivity adhesive. A bond line between the ceramic phosphor converter and the substrate has a thermal conductance of at least 0.05 W/K.

### BRIEF DESCRIPTION OF THE DRAWINGS

FIG. 1 is a schematic illustration of a reflective LARP configuration employing a target according to this invention.

FIG. 2 is a schematic illustration of a reflective LARP target according to this invention.

FIG. 3 is a plot of calculated net conversion efficiency for a 1 mm×1 mm×0.1 mm phosphor volume with reflective surfaces on the back and sides.

FIG. 4 is a plot of calculated temperature in a 2% Ce:YAG ceramic phosphor as a function of distance from the pump laser irradiated surface at z=0 μm for different bonding interfaces.

FIG. 5 is a plot of (i) measured converted power versus peak pump intensity for different ceramic phosphors as a function of laser intensity at low power and (ii) calculations of converted power versus peak pump intensity based on simple rate equation analysis.

FIGS. 6A and 6B are SEM images showing the minimum bond line thickness for a whole ceramic phosphor platelet on a substrate in a concave-up orientation and a magnified view of the bond line near its middle, respectively.

FIG. 7 is a plot showing converted power versus blue pump power (445 nm) for three different Ce:YAG samples: (a) ceramic phosphor platelets bonded with ZnO-filled silicone; (b) ceramic phosphors bonded with pure silicone; and (c) a reference sample of Ce:YAG fabricated from a powder phosphor in a sodium silicate matrix.

FIG. 8 is a plot showing conversion efficiency versus blue pump power (445 nm) for the samples of FIG. 7.

FIG. 9 is a plot showing converted pump power versus blue pump power (445 nm) for two different substrate reflectitivies: (a) ceramic platelets bonded to a 98% reflective silver coated substrate; (b) ceramic platelets bonded to a 95% reflective enhanced aluminum substrate.

FIG. 10 is a plot showing conversion efficiency versus blue pump power (445 nm) for the samples of FIG. 9.

FIG. 11 is a schematic illustration of a measurement system to characterize LARP ceramic phosphors.

FIG. 12 is a plot showing (i) maximum converted laser power (circles) versus LED-pinhole lumens/W-optical blue, and (ii) maximum blue power (squares) before roll-over, up to the 25 W maximum pump power.

FIG. 13 is a plot showing correlation between hemispherical forward transmission from BSDF measurements and corresponding QE measurements of ceramic phosphor samples fabricated with different final sintering conditions.

FIG. 14 is a plot showing measured spectral power distribution of a Ce:YAG converter at three pump powers.

FIG. 15 is a plot showing conversion power versus blue pump power (445 nm) for three different Eu²⁺:nitride-based ceramic phosphor targets (ZnO-silicone bonded, Ag-coated substrate) for green and red conversion compared with a Ce:YAG ceramic phosphor target (ZnO-silicone bonded, Ag-coated substrate).

### DETAILED DESCRIPTION OF THE INVENTION

For a better understanding of the present invention, together with other and further objects, advantages and capabilities thereof, reference is made to the following disclosure and appended claims taken in conjunction with the above-described drawings.

References to the color of a phosphor, laser, light emitting diode (LED) or conversion material refer generally to its emission color unless otherwise specified. Thus, a blue LED emits a blue light, a yellow phosphor emits a yellow light and so on.

As used herein, a ceramic phosphor converter refers to a solid, sintered polycrystalline photoluminescent material. Ceramic phosphor converters do not include phosphor converters comprising particles of a phosphor material dispersed in an organic or inorganic matrix.

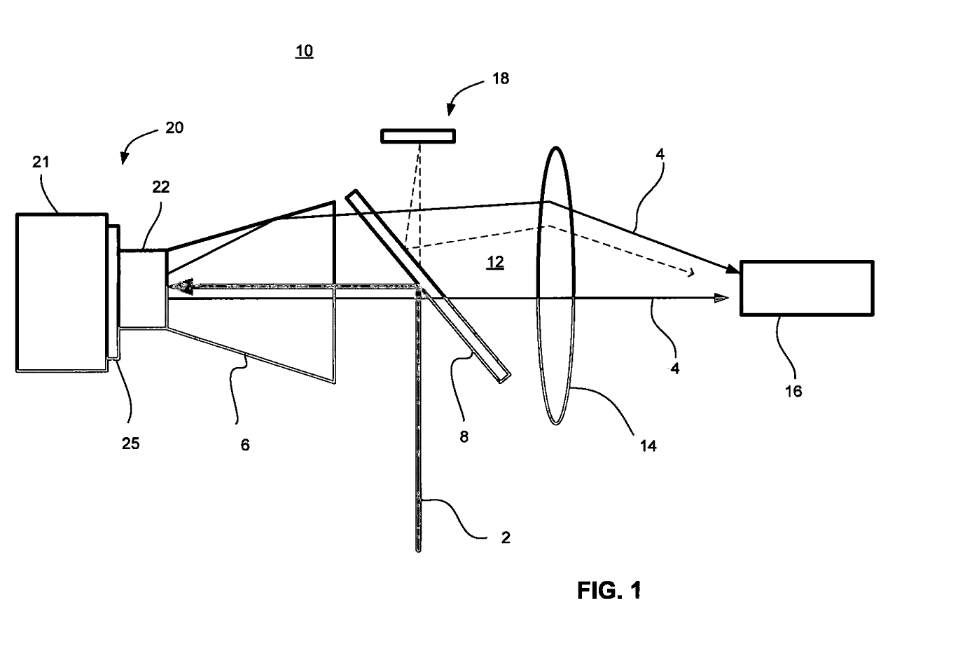

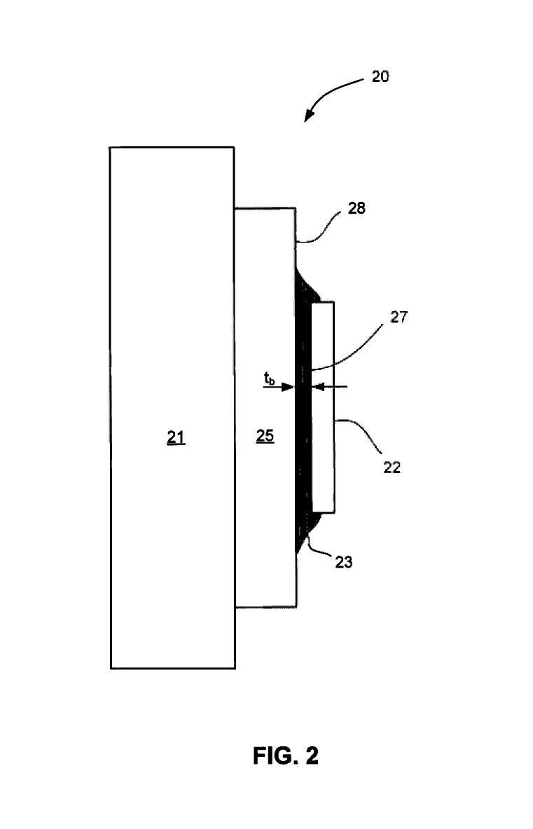

A preferred embodiment of the invention is shown in FIG. 2 for the reflective LARP configuration shown in FIG. 1. Reflective LARP target 20 comprises a ceramic phosphor converter 22 in the form of a platelet that is bonded to a high reflectivity surface 28 of metal substrate 25. A high thermal conductivity adhesive 23 is used to bond the converter 22 to the substrate 25 thereby forming bond line 27 of thickness to between converter 22 and substrate 25. The substrate 25 is preferably mounted to a heat sink 21 for dissipating the heat generated in the converter 22. In this embodiment, a filled silicone, e.g. ZnO-filled silicone, is preferably used as the adhesive 23 to bond the converter 22 to substrate 25. However, it is possible to use other adhesives such as a low-temperature glass, including, but not limited to, ZnO—B₂O₃—Bi₂O₃, lead-containing glasses such as lead phosphates, and related systems.

The basic principle of operation a reflective LARP system 10 is shown in FIG. 1. A dichroic beam splitter 8 reflects the incident laser pump light 2 but passes longer wavelength converted light 4. The incident blue laser 2 is focused onto the LARP target 20 having ceramic phosphor 22 through a collimating optic 6. The resulting converted light 4 is re-collimated and passed by the dichroic splitter 8 into the converted light channel 12, where the converted light is focused by lens 14 onto a fiber optic 16 or other projection optics. Additional color channels 18 may be added by incorporating additional light sources which may reflect off the dichroic splitter 8 shown in FIG. 1, or additional dichroics added into the color channel paths. The étendue of the converted light E≅πAₗₐₛₑᵣ, where Aₗₐₛₑᵣ is the incident laser spot area on the phosphor. As ceramics have high heat conductivities, on the order of a few W/m/K to tens of W/m/K, the heat produced by conversion losses can be efficiently dissipated, permitting much higher incident pump intensities before the onset of thermal quenching as compared to other approaches in which powder phosphors are embedded in an organic or glassy host.

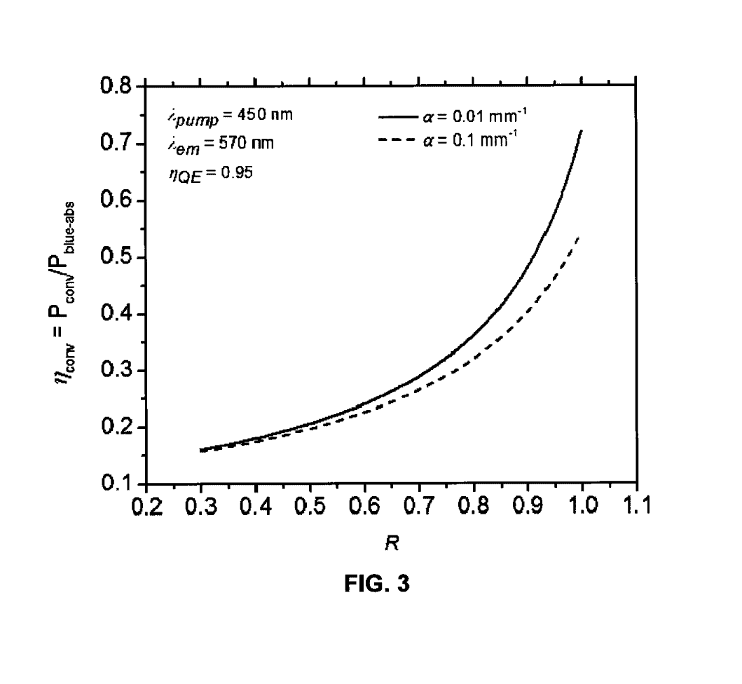

In order to achieve high conversion efficiency, reflectivity of the substrate surface must be at least 85%, with 95% or more being most desirable. In this way radiation initially emitted away from the desired forward direction can be recycled. FIG. 3 shows a calculation of the net conversion efficiency of a hypothetical luminescent 1.0 mm×1.0 mm×0.1 mm plate bound by a reflective layer of reflectance R on five of its six surfaces. The emitted light comes from the top surface. In this example, calculated by a photon rate equation approximation, the ceramic phosphor is assumed to have an internal quantum efficiency (QE) of η_{QE}=0.95, an incident pump wavelength of bump λₚᵤₘₚ=450 nm and an emission wavelength λₑₘ=570 nm. At R=1.0, the conversion efficiency η_{conv} is nearly equal to the product of internal QE and net conversion fraction after Stokes loss. For this example, η_{conv}=η_{QE}×η_{Stokes}=0.75, where η_{Stokes}=λₚᵤₘₚ/λₑₘ. Since the calculation includes the effect of small added volume absorptivities (1/mm), denoted by α, the conversion efficiency at R=1.0 for even α=0.01 mm⁻¹ is slightly below the theoretical value of 0.75. Ceramics have very low internal losses and are therefore well suited for such applications. The larger volume loss value α=0.1 mm⁻¹ shows, for example, the possible effect of activator ion self-absorption losses on the blue side of the emission spectrum; here one can see that even a 1% self-absorption loss across the 0.1 mm thickness of the ceramic can lead to significant losses at those wavelengths. However, this does not take into account the possible effect of re-emission by the self-absorbed photons. Implicit in these calculations is that scattering within the ceramic and/or interfaces is strong enough such that the radiation is isotropic. In practice, scattering must be present in the phosphor conversion system to provide light extraction; if no scattering is present, light is eventually absorbed through very large numbers of multiple total-internal reflection (TIR) bounces.

The ceramic phosphor converter itself can be one of many photoluminescent materials, including cerium-activated garnets having the general formula (Y,Lu,Gd)₃Al₅O₁₂:Ce, for example, Y₃Al₅O_{12:}Ce (Ce:YAG), Lu₃Al₅O₁₂:Ce (Ce:LuAG) and (Y,Gd)₃Al₅O₁₂:Ce (Ce:GdYAG) as well as europium-activated oxynitrides having the general formula (Ba,Ca,Sr)Si₂O₂N₂:Eu, for example SrSi₂O₂N₂:Eu (Eu:SrSiON), and many other ceramic phosphor materials known in the art. Preferably, the ceramic phosphor is one of Ce:YAG, Ce:LuAG, Ce:GdYAG, or Eu:SrSiON. Materials are determined by desired color points, with Ce-based ceramics typically used for green or yellow converters, and Eu-based nitrides for red or amber. Fabrication of ceramic platelets can be accomplished by a variety of ceramic forming methods followed by a sintering process. Desired thicknesses can be achieved through cutting and grinding, or lamination. Typical platelet thicknesses are on the order of 100 μm, but can have considerable variation depending on specific applications. Final sintering parameters determine the scattering length in the material. Typically, platelet thickness should be at least twice the scattering length, and preferably more, to achieve sufficient back-scattering and extraction of luminescent radiation. Scattering is achieved through pores that form at grain boundary intersections in the case of isotropic materials such as yttrium aluminum garnet (YAG) and/or grains themselves in the case of anisotropic materials such as most nitrides. Additionally, scattering centers can be introduced through second phases or special fillers. Typically scattering center dimensions roughly lie in a range of 100 nm to a few microns, as this range provides the most efficient scattering for a given volume fraction of scatterers. Well below 100 nm, scattering cross-sections become small relative to their geometric cross-sections at visible wavelengths. On the other hand large scatterers can have large cross-sections but occupy considerable volume per scatterer, requiring high porosity in the ceramic to reach low enough scattering lengths. This is undesirable for good thermal conductivity, adsorption of atmospheric contaminants, and often reduces quantum efficiency. Furthermore, larger scatterers have highly forward directed scattering, making them less effective for backscattering.

Preferably, the ceramic phosphor platelet is bonded to the substrate with an optically non-absorptive, high thermal conductivity adhesive. The adhesive can be one of many higher thermal conductivity bonding materials, including alumina or zinc-oxide filled silicones, and low temperature glasses. The adhesive does not have to be optically transparent; in fact a high scattering (but non-absorbing) adhesive may even have a positive impact by backscattering light without absorption before reaching the reflective substrate. Preferably, the adhesive must simultaneously satisfy several criteria. This includes attainment of very thin bond lines, having high thermal conductivity, and negligible absorption at optical wavelengths. For applications employing laser intensities on the order of 10⁷ Wm² or more, adhesives should have thermal conductivities on the order of 0.5 W/m/K and attain bond lines of less than 10 μm, preferably 5 μm in the region over which pump light is incident on the ceramic. For a spot area of 1 mm², this leads to a thermal conductance on the order of 0.1 W/K.

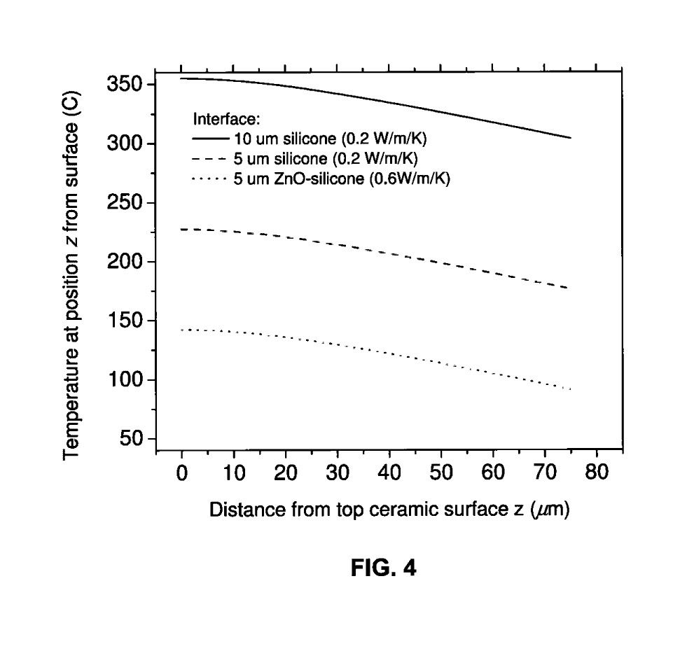

Conversion efficiencies η_{conv} in typical ceramic phosphors are on the order of 50-80%, depending on the quantum efficiency and Stokes shift. Most phosphor materials have strong thermal quenching 100-150° C. above room temperature. If we therefore limit the temperature difference across the adhesive interface to 100° C. and assume phosphor losses on the order of 30-50%, on the basis of the above argument, maximum achievable pump powers into a 1 mm² area are on the order of 20-30 W, but scaling above these values are possible with the invention. Currently, this is well above the radiant emittance of commercial LEDs. FIG. 4 shows a representative 1 D calculation (with effective thermal resistances of the passive structures) for unfilled silicone and filled silicone adhesives used to bond a 75 μm thick ceramic phosphor platelet onto a high reflective Al substrate. The substrate is then mounted on a Cu heatsink held at 35° C. Laser power was 25 W with a spot that was assumed to fill a 1.4 mm×1.4 mm square Ce:YAG ceramic. The thermal conductivity of the ceramic phosphor was assumed to be 5 W/m/K. The results confirm the result that a very thin bond line using filled silicones with ceramics are sufficient for a static LARP phosphor target with radiances that exceed those possible with current high power blue LEDs with ceramic converters or special high luminance LEDs.

To maintain a thin bond line thicknesses, ceramic platelets should be flatter than the required bond line thickness. This can be achieved through grinding and polishing; however, it may be desirable to eliminate the grinding and polishing steps because platelet thicknesses are harder to control and such steps can add extra production costs. With some methods of ceramic fabrication, platelets can made be relatively flat, but may display camber. In this case, samples can be bonded concave side up such that just the region which is excited by the pump light maintains the desired bond line thickness.

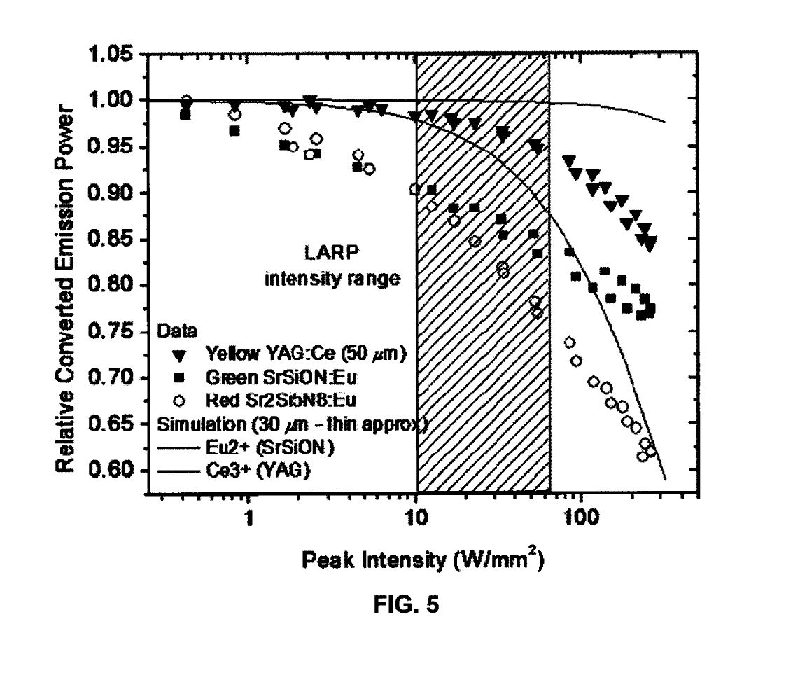

In addition to thermal quenching due to the high thermal load of the laser pump light, pump intensities in LARP applications can also reach values at which ground state depletion and optical saturation effects become important. FIG. 5 shows relative measurements of the luminescent light versus pump intensity. Pump intensity was measured using a low power blue laser (30 mW) with an adjustable focus to vary the intensity. Both time-dependent measurements and calculations confirm that the drops in efficiency in FIG. 5 were not due to phosphor heating. Since Ce³⁺ activators have a lifetime of 60-70 ns, one would expect pump intensities can be quite high before optical saturation effects become important. This is evident from the simple rate equation analysis shown in FIG. 5 for Ce:YAG where the loss of efficiency is simply from saturated absorption (less blue absorption from ground state depletion) and an excited state absorption that is known to occur in many Ce-based phosphors. For the case of Eu²⁺, lifetimes are on the order of 1 μs, leading to much greater sensitivity to optical pumping. This is both shown in the data and simple calculation. What is important in these results is that optical pumping effects, even with the Eu²⁺ ceramic phosphors measured, show efficiency losses of only 30% at 10⁸ W/m² pump power. This shows that, provided the ceramic phosphor targets can sufficiently transfer heat from the pump beam to the substrate, one can reach very high luminescent intensities.

In one embodiment of the invention, the ceramic phosphor is Ce:YAG with a Ce doping level of 2% (2% substitutional replacement of Y ions by Ce ions). The ceramic platelet is between 60-150 μm thick and has an area of 1-10 mm². The platelet is glued to a highly reflective substrate with reflectivities on the order of 95-98%. In particular, targets were constructed using two coated Al substrates: an enhanced, protected Al reflective surface with a reflectance of 95% and a protected Ag coated Al substrate with a reflectance of 98% over most visible wavelengths. The substrates are 0.75 mm thick.

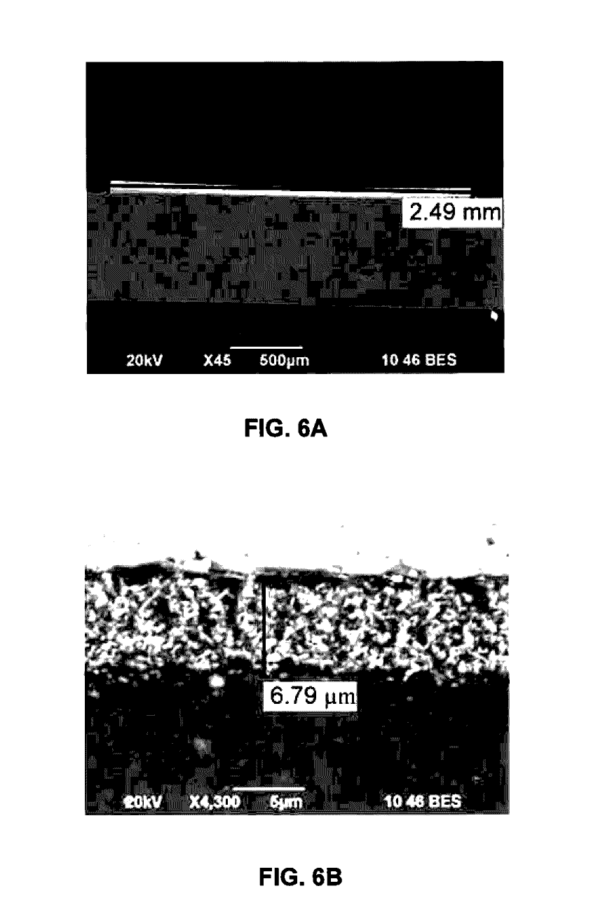

The ceramic platelets are glued to the reflective substrate by application of a thin layer of ZnO-filled silicone onto the substrate and then the platelet is pressed into the filled silicone layer with a fixture to apply pressure so that bond lines on the order of 5 μm can be achieved. FIG. 6 shows an example of the platelet glued to the enhanced Al substrate with the desired bond line thickness. The platelet was oriented such that the camber was concave up to minimize the thermal path to the substrate. Filled silicone that wicks up sides also serves as an additional reflective scattering layer to recycle radiation back into the emitting volume that may reach the edges.

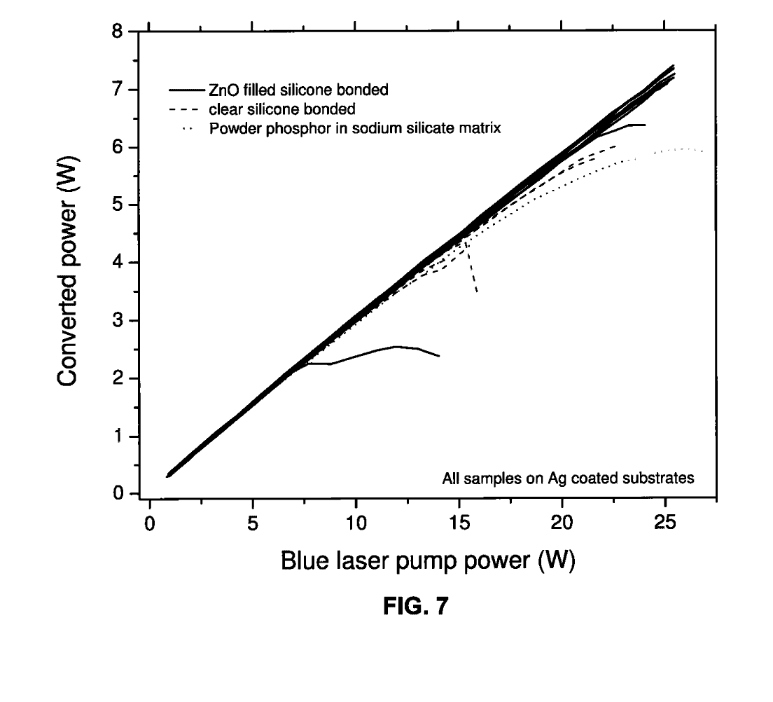

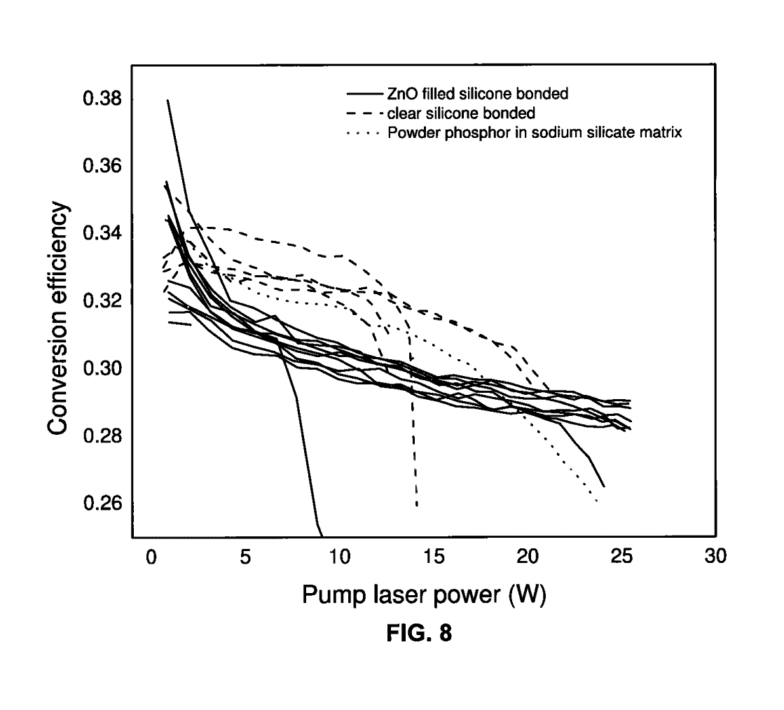

FIGS. 7 and 8 show a comparison of experimental measurements for a large number of samples based on Ag-coated substrates using pure silicone bonding versus ZnO-filled silicone. In these samples, platelet orientation was random: platelets were both concave up and down. Also for comparison, a LARP sample fabricated from Ce:YAG phosphor powder in a sodium silicate matrix on a silica protected Ag-coated substrate is included. Data were taken using an optical test system similar to that shown in FIG. 1, where pump power is coupled into the phosphor targets with a hexagonal TIR focusing optic. The pump source was generated by a collimated array of laser diodes at 445 nm and provides a maximum incident pump power of about 25 W at the ceramic phosphor surface. The pump spot on the ceramic is approximately 2.1 mm². The TIR optic collects converted light over a range of approximately ±70°. The dichroic beam splitter in FIG. 1 has a reflective cutoff wavelength of about 500 nm. A set of collimating lenses (not shown) collimate the converted light (wavelengths longer than 500 nm) onto a thermopile-based power meter head.

Note that all the pure silicone based samples in FIG. 7 show rather large drops in efficiency as one approaches the maximum pump power of 25 W. This is observed more clearly in FIG. 8 which shows the actual efficiencies. This is a result of thermal quenching as phosphor temperatures reach 100-150° C. in the pump spot region. This has been verified by thermal temperature measurements. Furthermore, all the pure silicone bonded samples show a rapid and sometimes catastrophic drop in converted power before reaching the full pump power. This thermal roll-over effect is essentially a thermal run-away effect: as the region of the ceramic phosphor that is irradiated by the pump light increases in temperature, the non-radiative losses consequently increase, resulting in yet further localized pump absorption. If this excess thermal load cannot be adequately dissipated through the ceramic and bond interface, the temperature in the pump region will increase until either the sample is damaged or in some cases a new equilibrium is found. Temperature measurements on ceramics in this roll-over condition indicate peak temperatures in excess of 300° C. The reference sample, based on a sodium silicate matrix, shows a similar thermal quenching, but the sample was able to reach 25 W pump power without thermal roll-over.

The ZnO-filled silicone samples show qualitatively different behavior, with nearly all samples reaching the full 25 W pump power without roll-over. The few samples that do show roll-over are likely attributed to thicker than desired bond lines, ceramics with high camber and concave down mounting that limit heat transfer, or to defects in construction or in the ceramic. In general, the ZnO-filled silicone samples show much less thermal quenching than the other samples, indicating that the peak temperatures of the ceramic are lower than for the silicone only or sodium silicate samples. From FIG. 8, one can observe that the pure silicone bonded samples show better efficiency over a range of low pump powers, but show a rapid drop in efficiency at some threshold pump power; the ZnO-filled silicone samples simply show a modest efficiency drop with pump power up to 25 W. Furthermore, the ZnO-filled silicone samples show much more sample-to-sample consistency than for the pure silicone samples. The reason for the slightly lower overall efficiency of the ZnO-filled silicone samples compared to pure silicone samples (below strong thermal quenching points) is not entirely clear, although it may be related to the additional scattering of the filled silicone at the reflective substrate which in this case may be enhancing losses slightly. In particular, evanescent excitation by scattering particles very close to the substrate could lead to additional plasmon excitation and contribute to further losses in the reflective substrate.

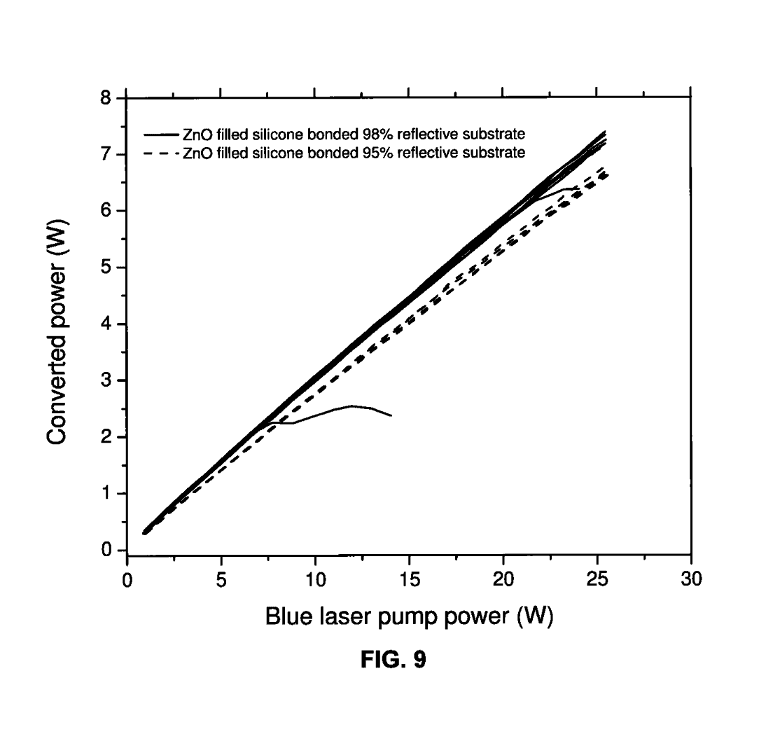

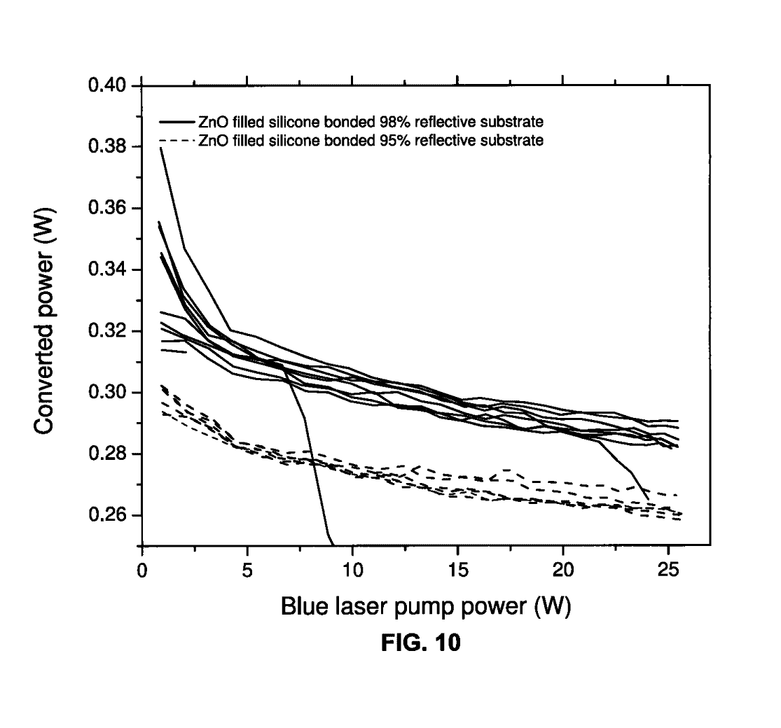

FIGS. 9 and 10 show the effect of substrate reflectivity on converted power and conversion efficiency. From FIG. 10, one can see that about a 6-7% loss in conversion efficiency resulted from only a 3% change in reflectivity. A similar loss is predicted in FIG. 3. While it would appear that the Ag-coated substrate would be optimal, the enhanced Al substrate may be preferred in some applications where well-known degradation of Ag can occur from atmospheric sulfur.

Scattering from pores and/or second phases in the ceramic contribute to overall performance of the invention. If scattering is weak, such that the scattering length l_{scat} in the ceramic is on the order or larger than the thickness of the ceramic platelet, the platelet will appear quite transparent. In this case, radiation emitted outside of the critical angle cone will be subject to a large number of TIR reflections. This will lead to one of two scenarios: 1) the radiation will eventually be absorbed, leading to large overall losses or equivalently, poor light extraction; or 2) radiation will eventually exit the platelet through the edges if within the edge critical angle cone or through the edges or surfaces through light recycling by the weak volume or surface scattering. In the second case, a significant amount of radiation will appear far outside of the desired pump region. This would negate any gain in radiance one would have with laser excitation.

In the opposite case, ceramics with very strong scattering have scattering lengths much smaller than any geometric length. In this regime, incident blue light is absorbed only near the surface. This is because of the consequent strong backscattering. This also implies that the emission region is close to the surface. This can be advantageous because scattering within the ceramic contributes significantly to backscattering in the desired direction, reducing the effect of losses at the reflective substrate. Furthermore, the high scattering tends to confine the emission spot, therefore keeping emission source area very close to the incident laser spot area. This implies highest coupling efficiency into the collimating optics and lowest source étendue. However, a disadvantage of operating at very small scattering lengths, say a factor of 20-100 smaller than the platelet thickness, is that heating is confined to a thin region furthest from the substrate. This effectively increases the thermal resistance to the substrate and heatsink. This will enhance thermal quenching and again reduce the usable radiance. A second problem with very strong scattering is that even in low loss materials like Ce:YAG ceramic, very small volume losses become greatly enhanced because of the greatly extended optical path lengths, leading to additional QE losses. Similarly any radiation emitted near the substrate will become nearly trapped, again leading to additional loss through multiple reflections with the slightly lossy reflective substrate.

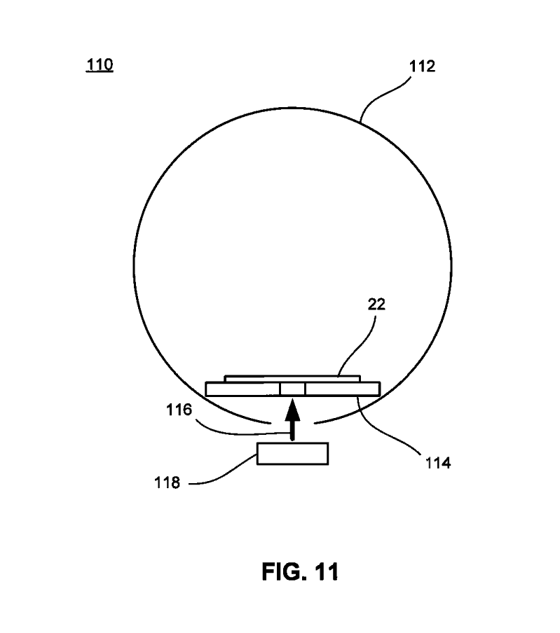

Therefore, an optimal scattering range will exist for a given configuration. A simple and effective way to characterize scattering is to illuminate a sample from one side and determine how much total light is either backscattered or transmitted into a hemisphere. As the amount of scattering increases, backscattering must increase, or equivalently, the total forward hemispherical transmitted fraction must decrease. FIG. 11 shows a test apparatus 110 that measures the amount of transmitted light through a scattering sample. The ceramic phosphor sample 22 is illuminated by a diffuse light source. An absorbing pinhole aperture 114 with a 0.6 mm diameter hole combined illumination by light 116 from an LED source 118 provides a well defined optical source. As the amount of backscattering in the ceramic sample increases, emission, which is more confined to the entrance side of the ceramic sample, is backscattered into the LED and neighboring absorbing pinhole surfaces. Consequently, increased scattering implies a lower flux of emitted light into the sphere.

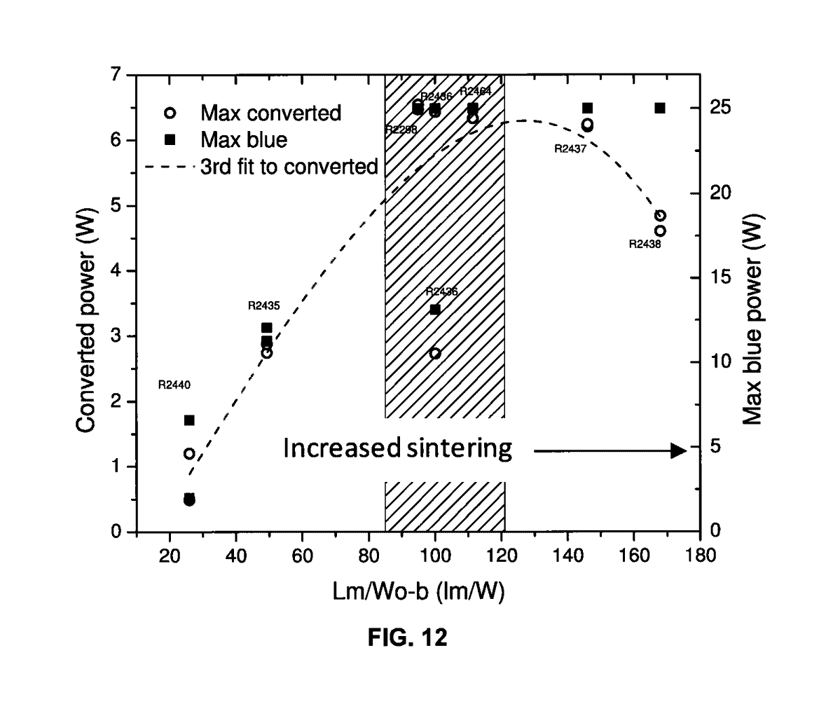

Referring to FIG. 12, one can see the result of increased sintering, and therefore reduced volume scattering in the ceramic, on converted power. In these data, a set of ceramic phosphor platelets fabricated as a single batch in the pre-sintered state, undergo different final sintering conditions. Platelets with the highest degree of sintering appear quite translucent and show the highest test efficacy (lm/W-optical blue) measured from the setup in FIG. 11. Sintering degree increases with increased Lm/Wo-b. Samples with the least amount of final sintering have the lowest test efficacies. The data clearly show an optimal region of scattering that maximizes converted laser power. This occurs for test efficacies in the 85-125 lm/W-optical blue range from the measurement apparatus shown in FIG. 11. At lower levels of lm/W-optical blue (higher scattering), converted powers drop sharply. This is primarily because the full 25 W blue pump power cannot be reached before roll-over occurs. At higher lm/W-optical blue (lower scattering and greater sintering), full blue power can be reached but converted power drops somewhat.

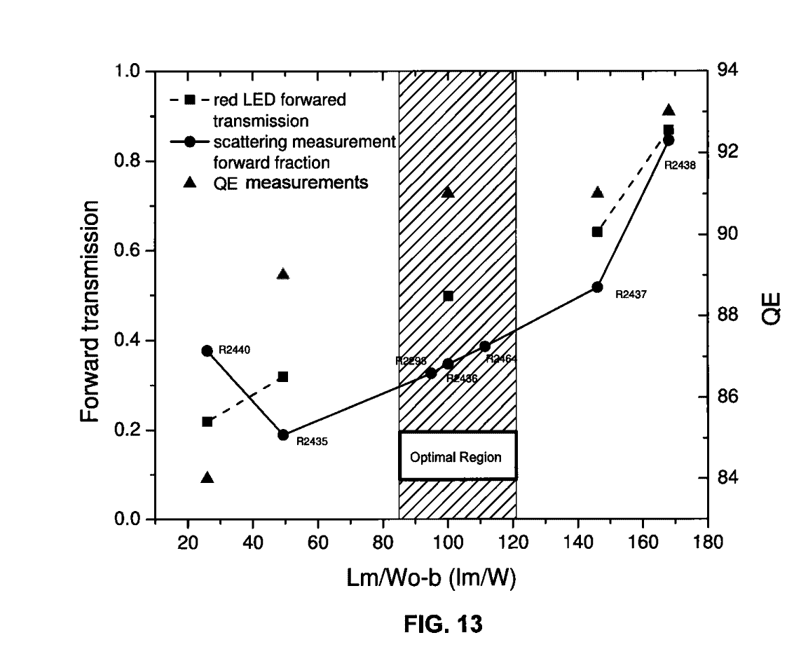

To better understand the behavior, FIG. 13 shows a plot of the measured forward scattering fraction into a hemisphere, taken from bi-directional scattering distribution functions (BSDFs) versus test efficacy. Additionally, separate QE measurements of the bare ceramic phosphors are plotted as well. From well-resolved BSDF measurements in the near specular forward direction, it was possible to estimate the scattering lengths for the two most translucent samples. Sample R2438 has a scattering length of approximately 108 μm, larger than the 70 μm nominal platelet thickness. Sample R2437 has a scattering length of 14.8 μm, considerably smaller than the 70 μm nominal platelet thickness. Scattering lengths in the higher scattering samples were too small to measure accurately, but were clearly less than 10 μm.

Firstly, one can see that higher values of test efficacy correlate with increased forward transmission from BSDF measurements, verifying that the simple efficacy test measurements are a sensitive measure of scattering. Secondly, the QE shows a modest but clear drop at high scattering levels. This implies the large amount of scattering is contributing to modest increases of internal loss within the ceramic. As shown in FIG. 3, even small amounts of internal volume loss can significantly reduce overall conversion efficiency.

The data in FIG. 12 can now be understood as follows: at low scattering, the decrease in converted power with R2438 must be due to loss of extraction efficiency since the scattering length is longer than the sample thickness. The loss is only slightly noticeable for R2437 which already has fairly strong scattering on the basis of the ratio of scattering length to sample thickness. On the other side of the plot where scattering is very strong, sample loss can be attributed both to loss of QE and temperature distributions being confined close to the pump side of the ceramic. Additionally, high porosity (more than a few volume percent) may contribute to reduced thermal conductivity of the ceramic, increasing surface temperatures and the likelihood of roll-over.

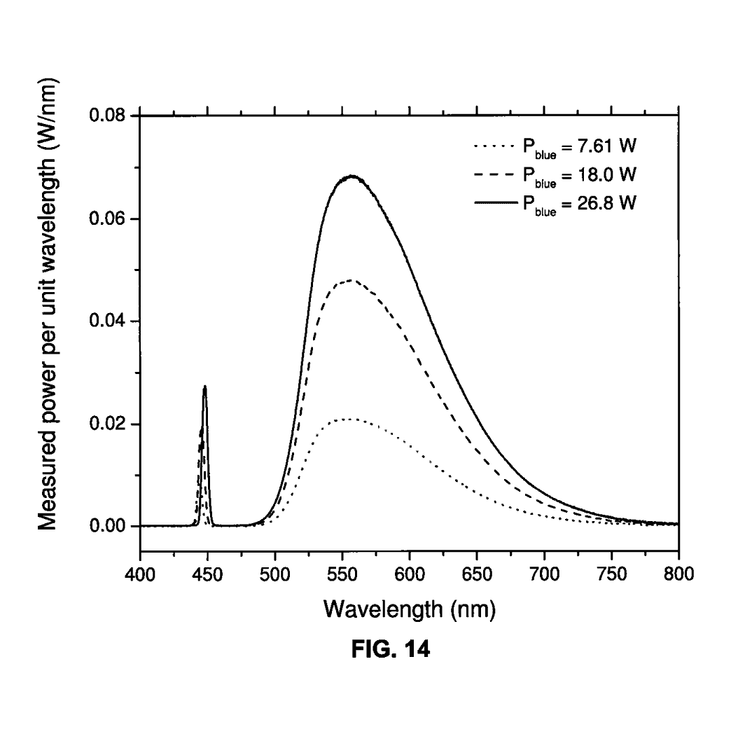

FIG. 14 shows plots of the spectral power density from the Ce:YAG ceramic at different blue pump powers using the test setup similar to that shown in FIG. 1. These data were taken for a ceramic platelet mounted on a silver coated substrate with ZnO-filled silicone. The spectral data were taken using a calibrated integrating sphere-fiber spectrometer system. The data were calibrated absolutely using the power meter measurement already described. The data show that the spectra are highly consistent, even at the highest pump powers. The weaker blue emission is leakage through the dichroic. From these data and taking a TIR optic collection angle θ₀±70° (estimated from measurements), one can estimate the radiance L_{R} and luminance L_{Φ} of the emission spot on the ceramic phosphor target. If the measured converted power is denoted by P_{conv}, and the luminous flux is denoted by Φ_{conv}, the corresponding radiance and luminance are given approximately by,

$$\begin{matrix}{L}_{R} = \frac{{P}_{conv}}{π Af} , & ( 1 ) \\ {L}_{Φ} = \frac{{Φ}_{conv}}{π Af} . & ( 2 )\end{matrix}$$

Here, A is the area of the emission spot and f=sin² θ₀ is the fraction of Lambertian radiation into a cone of half-angle θ₀.

Table 1 shows estimated radiance and luminance values. The radiance and luminance values obtained are considerably higher than comparable high-performance LED-based projection light sources by as much as a factor of two. Furthermore, the ceramic LARP approach can scale to even higher powers for the same étendue. LED-based devices are much more limited in this respect.

TABLE 1
CERAMIC LARP PHOTOMETRIC MEASUREMENTS (Ag coated Al substrate)

| Laser | Incident | Measured | Measured | Estimated | | | |
|---|---|---|---|---|---|---|---|
| diode | blue | converted | luminous | L_{R} | L_{Φ} | L_{R} | L_{Φ} |
| current | power | power P_{conv} | flux Φ_{conv} | (W/m²/sr) | (Cd/m²) | (W/m²/sr) | (Cd/m²) |
| (A) | (W) | (W) | (lumens) | (θ₀ = 90°) | (θ₀ = 90°) | (θ₀ = 70°) | (θ₀ = 70°) |
| 0.50 | 7.61 | 2.32 | 1103 | 3.52 × 10⁵ | 1.67 × 10⁸ | 3.99 × 10⁵ | 1.89 × 10⁸ |
| 1.00 | 18.0 | 5.27 | 2489 | 7.99 × 10⁵ | 3.79 × 10⁸ | 9.05 × 10⁵ | 4.29 × 10⁸ |
| 1.50 | 26.8 | 7.54 | 3528 | 1.14 × 10⁵ | 5.35 × 10⁸ | 1.29 × 10⁵ | 6.06 × 10⁸ |

A Ce:YAG ceramic platelet, bonded to either enhance Al or Ag coated (and protected) Al substrates with ZnO-filled silicone glue provides a radiance of at least 1.0×10⁶ W/m²/sr or an equivalent luminance of at least 5.0×10⁸ Cd/m² and is particularly useful for laser intensities exceeding roughly 5×10⁶ W/m². In the first embodiment, platelets are bonded with ZnO-filled silicone adhesive having a bond line that does not exceed 10 μm over the area defined by the pump light spot incident on the ceramic phosphor. Preferably, bond line thicknesses should be on the order of 5 μm or less. This can be accomplished with adhesives having thermal conductivities greater than about 0.4 W/m/K. Generally, the thermal conductance of the bond line should be at least 0.05 W/K, with greater than 0.1 W/K being most desirable.

The substrate must have a reflectance of at least 85%, preferably 95%, with >98% being most desirable. The lateral platelet dimensions are determined by the incident pump spot and generally must be at least equal to the pump spot size, and preferably have an area of at least 25% larger than the pump spot area. If the platelet size nearly matches the pump spot, either wicked ZnO-filled silicone or added TiO₂-filled silicone (or similar scattering materials known in the art) may be applied to the edges to recycle edge emission. Platelet thickness depends on Ce-doping and expected intensity levels; however platelets thinner than 30 μm may be exceedingly difficult to handle and mount. Cerium-YAG platelets of thicknesses exceeding 200 μm may have thermal resistances too large to adequately dissipate heat at pump laser intensities. These values are not fixed and are application dependent. Similarly, Ce concentration (fraction of Ce³⁺ ions replacing Y³⁺ ions) is application dependent and may be less than 0.1% for applications where only some of the pump light is converted to 4% where pump light is completely converted and the platelet is thin. Generally, Ce concentrations above 4% in YAG are difficult to achieve and not desirable because of strong non-radiative quenching due to Ce—Ce interactions.

Finally, ceramic platelets are sintered such that scattering lengths l_{scat} are less than half of the platelet thickness t, preferably satisfying

$$0.02 < \frac{{l}_{scat}}{t} < 0.2 . \qquad ( 3 )$$

Typical pore diameters in the ceramic may range from 100 nm-2 μm for most efficient scattering, i.e., lowest ceramic porosity and minimal directed forward scattering, but can lie outside this range for the invention to work properly. Similarly, second phases within the ceramic can also be used for scattering.

Since scattering lengths are difficult to measure in highly scattering samples, the hemispherical forward scattering fraction f_{f} may be used:

0.2<f_{f}<0.7, (4)

more preferably,

0.3<f_{f}<0.5, (5)

noting that depending on pore sizes, the optimal forward scattering fraction range may change.

A third approach for characterizing the optimal range of scattering is using the test setup in FIG. 11, where the measured luminous efficacy in lm/W-optical-blue should lie in a range, 40<Lm/Wo-b<160, and more preferably, 85<Lm/Wo-b<125. Again, the absolute values of this measurement may depend on additional factors such as ceramic phosphor QE, pore sizes, and sample thickness.

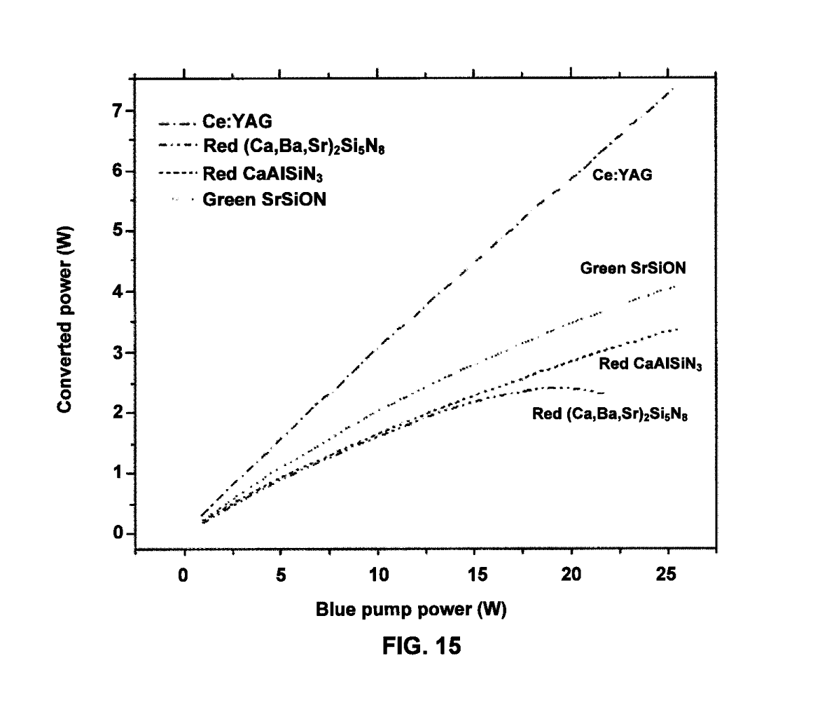

In a second embodiment of the invention, the yellow emitting Ce:YAG ceramic phosphor is replaced with other luminescent ceramics known in the art. As an example, samples were made from three different Eu:nitride ceramic phosphors using standard methods. The data in FIG. 15 show the results of red and green emitting ceramic phosphor platelets bonded to Ag coated substrates with ZnO-silicone. While the overall powers do not match those of the Ce:YAG, the red CaAlSiN₃ and green SrSiON both reach the maximum 25 W pump power without rolling over.

In a third embodiment, the ZnO-filled silicone bonding adhesive is replaced by a silicone incorporating other fillers, including but not limited to cristobalite, quartz, aluminum oxide, zirconium oxide, and other fillers that have very low losses at the desired optical wavelengths. Other bonding agents might include filled epoxies or filled translucent thermo-plastics with thermal conductivities of 0.4 W/m/K or higher and low optical losses. In the case of filled thermo-plastics, the material is deposited on a heated substrate above the melting point, and the ceramic phosphor platelet is pressed into the molten material and then solidified. Again, it is preferred to minimize bond line thicknesses such that the effective thermal conductance of the interface is on the order of 0.1 W/K or more. Most of these materials however are not as robust as silicone in terms of aging in the presence of strong blue fluxes and high operating temperatures.

In a fourth embodiment, other luminescent ceramic, glass ceramic, or glass luminescent phosphors can be used to reach desired wavelengths.

In a fifth embodiment, the scattering in the sample is so strong due to low sintering that the scattering length is more than 20 times smaller than the sample thickness. In this case, diffusion approximation simulations of optical transport indicate backscattering within the ceramic may account for more than 50% of the desired reflected light. As a consequence, one can relax the reflectivity constraints on the substrate, provided the QE losses and reduced thermal transport can be tolerated.

In a sixth embodiment, the combination of scattering and activator ion concentration are adjusted such that incident pump light is only partially converted and partially reflected to achieve a particular set of color coordinates are achieved. This is useful for white light generation or other color-mixing applications.

In a seventh embodiment, the phosphor target as described is integrated into additional optics that may improve light collection such as bonding a compound parabolic concentrator (CPC) to the emitting side of the phosphor. Alternatively, optical components could actually be transparent ceramics and integrated into the light converting part by various means known in ceramic technology. This includes co-sintering and injection molding. Such components could also be coated to enhance reflectivity or perform other optical functions to aid specific applications.

In addition to LARP applications, which include projection, automotive lighting, and general lighting, the invention could also be used for other high radiance, high thermal load light sources such as aperture lamps that use ceramic converters, and random lasers. One could also use low scattering ceramics together with high scattering surface structures to provide extraction. This could provide slight increases in conversion efficiency or permit structured far-field emission. In this case, one could use this technology for certain general lighting applications where a desired beam pattern is produced.

While there have been shown and described what are at present considered to be preferred embodiments of the invention, it will be apparent to those skilled in the art that various changes and modifications can be made herein without departing from the scope of the invention as defined by the appended claims.

What is claimed is:

1. A ceramic phosphor target, the target comprising:
a substantially flat ceramic phosphor converter comprised of a photoluminescent polycrystalline ceramic, the ceramic phosphor converter being attached to a reflective surface of a metal substrate by a high thermal conductivity adhesive whereby a bond line between the ceramic phosphor converter and the substrate has a thermal conductance of at least 0.05 W/K.

2. The target of claim 1 wherein the bond line thickness between the ceramic phosphor converter and the substrate is less than 10 micrometers.

3. The target of claim 1 wherein the adhesive has a thermal conductivity of at least 0.4 W/m/K.

4. The target of claim 1 wherein the adhesive is a zinc-oxide filled silicone.

5. The target of claim 1 wherein the ceramic phosphor converter is comprised of at least one of Ce:YAG, Ce:LuAG, Ce:GdYAG, or Eu:SrSiON.

6. The target of claim 1 herein the reflective surface has a reflectivity of at least 85% with respect to the light emitted by the ceramic phosphor converter.

7. The target of claim 1 wherein the bond line has a thermal conductance of greater than 0.1 W/K.

8. The target of claim 1 wherein the ceramic phosphor converter has a scattering length between 0.02 t and 0.2 t where t is the thickness of the ceramic phosphor converter.

9. The target of claim 1 wherein the target provides a radiance of at least 1.0×10⁶ W/m²/sr.

10. The target of claim 9 wherein the ceramic phosphor converter is comprised of Ce:YAG and the adhesive is a zinc oxide-filled silicone.

11. The target of claim 1 wherein the ceramic phosphor converter has a slightly concave surface which faces away from the reflective substrate.

12. The target of claim 1 herein the reflective surface has a reflectivity of at least 95% with respect to the light emitted by the ceramic phosphor converter.

13. The target of claim 1 wherein the target has a thickness of no more than 200 micrometers.

14. The target of claim 1 wherein the bond line thickness between the ceramic phosphor converter and the substrate is less than 5 micrometers.

15. The target of claim 1 wherein the ceramic phosphor converter has a forward scattering fraction between 0.2 and 0.7.
